(19) United States
(12) Patent Application Publication
(10) Pub. No.: US 2012/0166067 A1
(43) Pub. Date: Jun. 28, 2012

(54) METHOD FOR CONTROLLING A FUEL INJECTOR

(75) Inventors: Scott E. Parrish, Farmington Hills, MI (US); Ronald J. Zink, Macomb, MI (US); Paul M. Najt, Bloomfield Hills, MI (US)

(73) Assignee: GM GLOBAL TECHNOLOGY OPERATIONS LLC, Detroit, MI (US)

(21) Appl. No.: 13/280,427

(22) Filed: Oct. 25, 2011

Related U.S. Application Data
(60) Provisional application No. 61/427,248, filed on Dec. 27, 2010.

(51) Int. Cl. F02D 41/30

(52) U.S. Cl. 701/104

(57) ABSTRACT

A method for determining injected fuel mass delivered from an electromagnetic solenoid-activated fuel injector during a fuel injection event includes determining a sensed injection duration and a maximum injection mass flowrate during the fuel injection event, and determining the injected fuel mass for the fuel injection event based on the sensed injection duration and the maximum injection mass flowrate during the fuel injection event.

### CROSS REFERENCE TO RELATED APPLICATIONS

This application claims the benefit of U.S. Provisional Application No. 61/427,248, filed on Dec. 27, 2010, which is incorporated herein by reference.

### TECHNICAL FIELD

This disclosure is related to solenoid-activated fuel injectors.

### BACKGROUND

The statements in this section merely provide background information related to the present disclosure. Accordingly, such statements are not intended to constitute an admission of prior art.

Fuel injectors may be configured to directly inject pressurized fuel into combustion chambers of internal combustion engines. Known fuel injectors include electromagnetically-activated solenoid devices that overcome mechanical springs to open a valve located at a tip of the injector to permit fuel flow therethrough. Injector driver circuits control flow of electric current to the electromagnetically-activated solenoid devices to open and close the injectors. Injector driver circuits may operate in a peak-and-hold control configuration or a saturated switch configuration.

Injector operation may be characterized in terms of fuel mass per fuel injection event determined in relation to duration of injector open time and fuel pressure. Injector characterization includes metered fuel flow over a range between high flowrate associated with high-speed, high-load engine operation and low flowrate associated with engine idle conditions. Fuel injectors are calibrated, with a calibration including an injector open-time, or duration, and a corresponding metered fuel mass when operating at a predetermined or known fuel pressure. An injector characterization may include a region of linear operation and a region of non-linear operation.

A region of linear operation is a region of injection durations whereat the injection duration results in metering a corresponding and predictable injected fuel mass at a known fuel pressure. A region of non-linear operation is a region whereat the injection duration may not result in metering a corresponding and predictable injected fuel mass at a known fuel pressure. Known solenoid actuated injectors exhibit nonlinear flow characteristics when metering small quantities of fuel at low injection durations. Known engine operating systems avoid operating fuel injectors in non-linear regions of operation.

### SUMMARY

A method for determining injected fuel mass delivered from an electromagnetic solenoid-activated fuel injector during a fuel injection event includes determining a sensed injection duration and a maximum injection mass flowrate during the fuel injection event, and determining the injected fuel mass for the fuel injection event based on the sensed injection duration and the maximum injection mass flowrate during the fuel injection event.

### BRIEF DESCRIPTION OF THE DRAWINGS

One or more embodiments will now be described, by way of example, with reference to the accompanying drawings, in which:

FIG. 1 is a schematic sectional view of a fuel injector and control system, in accordance with the disclosure;

FIG. 2 illustrates injected fuel mass (mg) in relation to injection duration (ms) for exemplary direct injection fuel injectors, in accordance with the disclosure;

FIG. 3 graphically illustrates parameters associated with a single fuel injection event, including injector current, injector voltage, injector pressure, and an injection flowrate, in accordance with the disclosure;

FIG. 4 illustrates a control scheme in flowchart form to determine an injected fuel mass for a fuel injection event, in accordance with the disclosure; and

FIG. 5 graphically illustrates injected fuel mass in relation to a product of measured injection duration and a maximum injection mass flowrate, in accordance with the disclosure.

### DETAILED DESCRIPTION

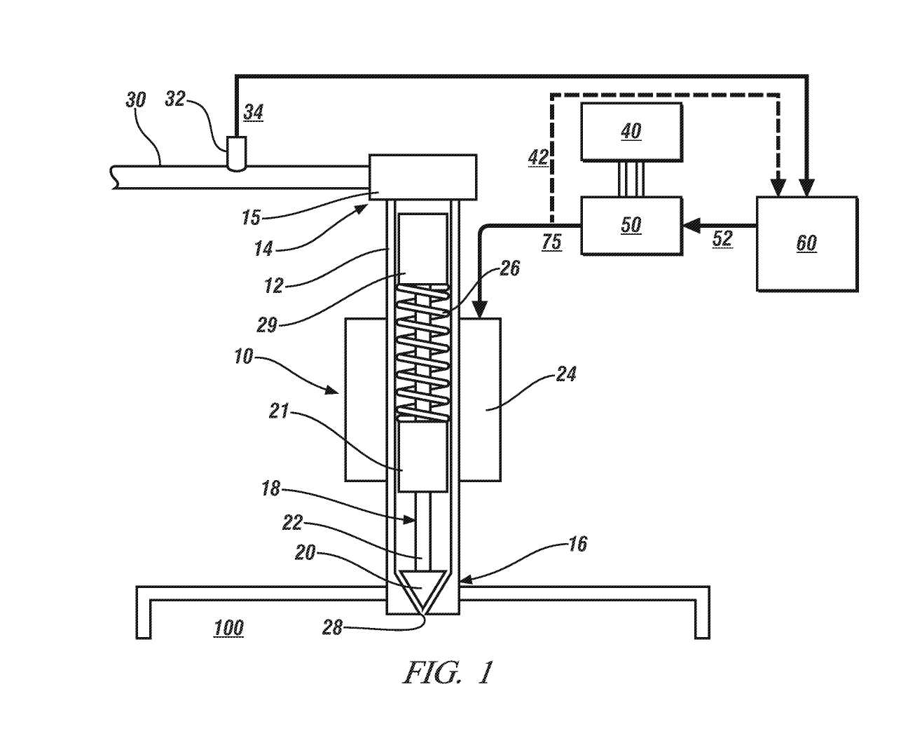

Referring now to the drawings, wherein the showings are for the purpose of illustrating certain exemplary embodiments only and not for the purpose of limiting the same, FIG. 1 schematically illustrates an embodiment of an electromagnetically-activated fuel injector 10. The electromagnetically-activated direct-injection fuel injector 10 is configured to inject fuel directly into a combustion chamber 100 of an internal combustion engine. A control module 60 electrically operatively connects to an injector driver 50 that electrically operatively connects to the fuel injector 10 to control activation thereof. The fuel injector 10, control module 60 and injector driver 50 may be any suitable devices that are configured to operate as described herein.

The fuel injector 10 may be any suitable discrete fuel injection device that is controllable to one of an open position (as shown) and a closed position. In one embodiment, the fuel injector 10 includes a cylindrically-shaped hollow body 12 defining a longitudinal axis. A fuel inlet 15 is located at a first end 14 of the body 12 and a fuel nozzle 28 is located at a second end 16 of the body 12. The fuel inlet 15 fluidly couples to a high-pressure fuel line 30 that fluidly couples to a high-pressure fuel injection pump. In one embodiment, the high-pressure fuel injection pump provides pressurized fuel at a line pressure of 20 MPa. A valve assembly 18 is contained in the body 12, and includes a needle valve 20 and a spring-activated plunger 22. The needle valve 20 interferingly fits in the fuel nozzle 28 to control fuel flow therethrough. An annular electromagnetic coil 24 is configured to magnetically engage a guide portion 21 of the valve assembly 18. When the electromagnetic coil 24 is deactivated, a spring 26 urges the valve assembly 18 including the needle valve 20 towards the fuel nozzle 28 to close the needle valve 20 and prevent fuel flow therethrough. When the electromagnetic coil 24 is activated, electromagnetic force acts on the guide portion 21 to overcome the spring force exerted by the spring 26 and urges the valve assembly 18 open, moving the needle valve 20 away from the fuel nozzle 28 and permitting flow of pressurized fuel within the valve assembly 18 to flow through the fuel nozzle 28. The fuel injector 10 may include a stopper 29 that interacts with the valve assembly 18 to stop translation of the valve assembly 18 when it is urged open. It is appreciated that other electromagnetically-activated fuel injectors may be employed without limitation. A pressure sensor 32 is configured to monitor fuel pressure 34 in the high-pressure fuel line 30 proximal to the fuel injector 10, preferably upstream of the fuel injector 10. In an engine configuration employing a common-rail fuel injection system, a single pressure sensor 32 may be employed to monitor fuel pressure 34 in the high-pressure fuel line 30 for a plurality of fuel injectors 10. It is appreciated that other configurations for fuel pressure monitoring proximal to the fuel injector 10 may be employed. The control module 60 monitors signal outputs from the pressure sensor 32 to determine the fuel pressure 34 proximal to the fuel injector 10 and monitors an injector voltage 42, i.e., electric potential across the electromagnetic coil 24 of the fuel injector 10.

The control module 60 generates an injector command signal 52 that controls the injector driver 50 to cause a fuel injection event. The injector command signal 52 correlates to a mass of fuel delivered by the fuel injector 10 during the fuel injection event. The injector driver generates an injector activation signal 75 in response to the injector command signal 52 to activate the fuel injector 10. The injector activation signal 75 controls current flow to the electromagnetic coil 24 to generate electromagnetic force in response to the injector command signal 52. An electric power source 40 provides a source of DC electric power for the injector driver 50. When activated using the injector activation signal 75, the electromagnetic coil 24 generates electromagnetic force to urge the valve assembly 18 open, allowing pressurized fuel to flow therethrough. The injector driver 50 controls the injector activation signal 75 to the electromagnetic coil 24 by any suitable method, including, e.g., pulsewidth-modulate electric power flow. The injector driver 50 is configured to control activation of the injector 10 by generating suitable injector activation signals 75.

The injector activation signal 75 is characterized by an initial peak pull-in current, a secondary hold current, and an injection duration. The initial peak pull-in current is characterized by a steady-state ramp up to achieve a peak current, which may be selected as described herein. The pull-in current generates electromagnetic force in the electromagnetic coil 24 that acts on the guide portion 21 of the valve assembly 18 to overcome the spring force and urge the valve assembly 18 open, initiating flow of pressurized fuel through the fuel nozzle 28. When the peak pull-in current is achieved, the injector driver 50 reduces the current in the electromagnetic coil 24 to the secondary hold current. The secondary hold current is characterized by a somewhat steady-state current that is less than the peak pull-in current. The secondary hold current is a current level controlled by the injector driver 50 to maintain the valve assembly 18 in the open position to continue the flow of pressurized fuel through the fuel nozzle 28. The secondary hold current is preferably indicated by a minimum current level.

Injection duration corresponds to an elapsed time that begins with initiation of the pull-in current and ends when the secondary hold current is released, thus deactivating the electromagnetic coil 24. When the electromagnetic coil 24 is deactivated, the electric current and corresponding electromagnetic force dissipate and the spring 26 urges the valve assembly 18 toward the nozzle 28, thus closing the fuel injector 10 and discontinuing fuel flow therethrough. The injection duration may be defined as a pulsewidth, preferably measured in milliseconds (ms).

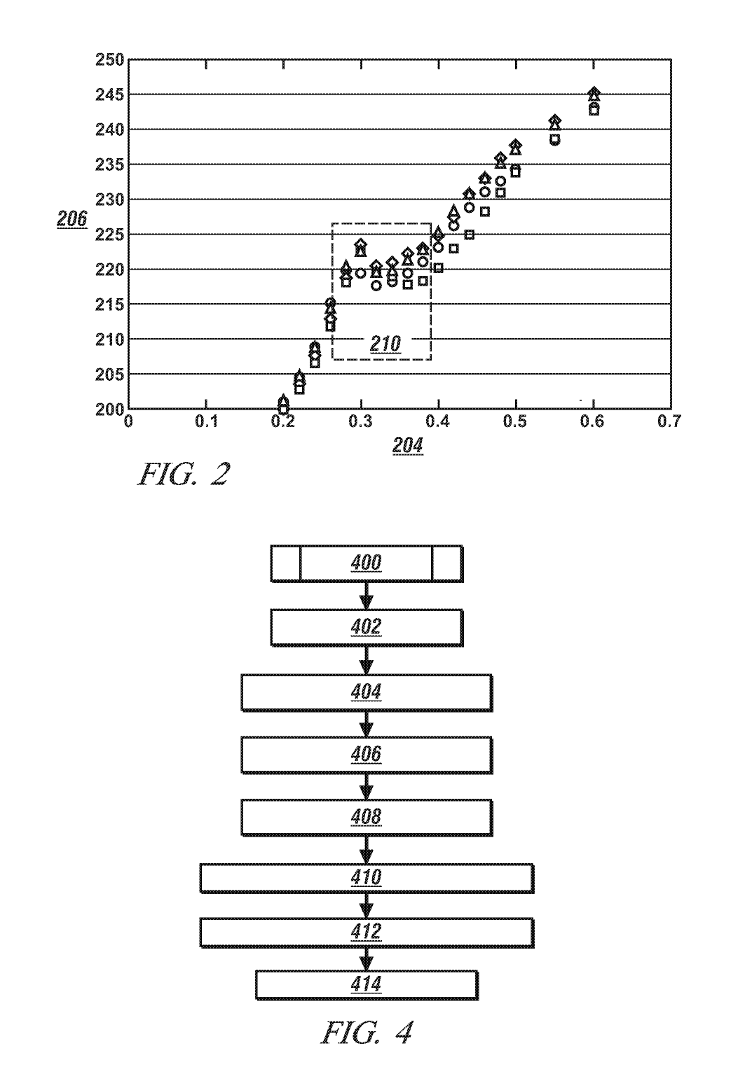

FIG. 2 illustrates data associated with operating four electromagnetically-activated direct-injection fuel injectors that have been manufactured to the same specifications. A commanded injection duration (ms), or pulsewidth, is shown on the horizontal axis 204 and injected fuel mass (mg) is shown on the vertical axis 206. The flow curves associated with operating the four electromagnetically-activated direct-injection fuel injectors are at low commanded injection durations, i.e., pulsewidths, and at a line fuel pressure of 20 MPa. As indicated, there is a non-linear region of operation 210, i.e., a region of injection duration whereat a change in the injection duration may not result in a corresponding and predictable change in injected fuel mass. Thus, an injected fuel mass may be achieved at more than one injection duration. The non-linear region of operation 210 occurs at injection durations between 0.25 ms and 0.40 ms in one embodiment (as shown), with corresponding injected fuel mass covering a range from less than 3 mg to greater than 5 mg. The non-linear region of operation 210 includes injector-to-injector flow variability. The commanded injection duration times and corresponding injected fuel masses are meant to be illustrative.

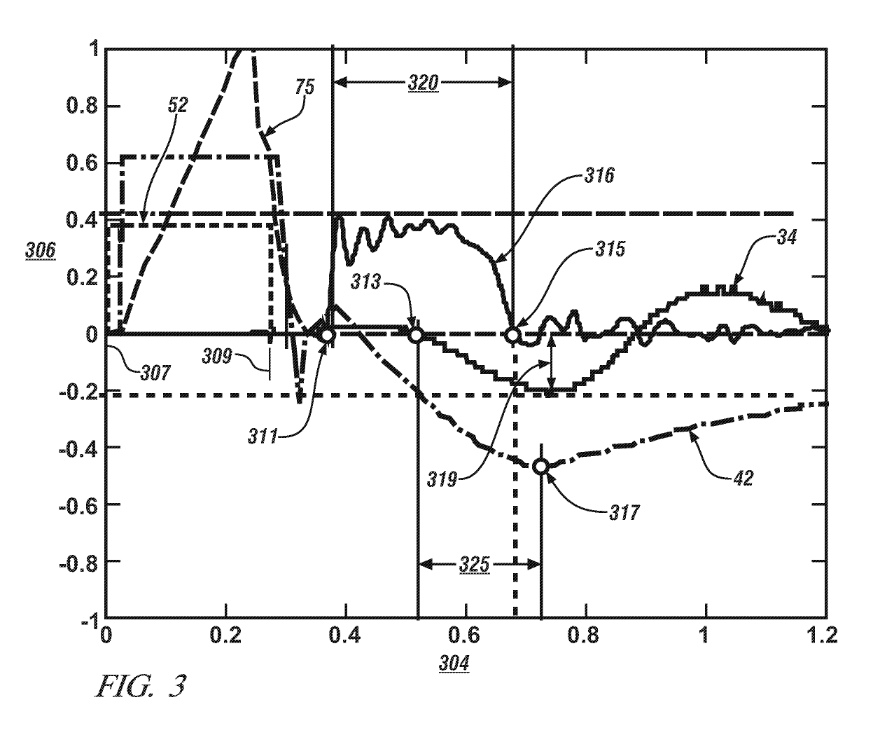

FIG. 3 graphically illustrates parameters associated with a single fuel injection event, with units of magnitudes on the vertical axis 306 plotted in relation to elapsed time (ms) on the horizontal axis 304. The parameters associated with a single fuel injection event include the injector command signal 52, the injector activation signal 75, the injector voltage 42, and the fuel pressure 34 proximal to the fuel injector 10, each which is described with reference to FIG. 1, and an injection flowrate 316, which is measured instantaneously.

Monitored time points associated with the single fuel injection event include a commanded start of injection (SOI) time 307 and a commanded end of injection (EOI) time 309 associated with the injector command signal 52, an actual SOI time 311 and an actual EOI time 315, and a sensed SOI time 313 and a sensed EOI time 317. The actual SOI time 311 and the actual EOI time 315 define an actual injection time 320, which correlates to actual flow of fuel as indicated by the injection flowrate 316. The sensed SOI time 313 and the sensed EOI time 317 represent time points that are associated with discernible changes in monitored parameters of the fuel injection system. The sensed SOI time 313 corresponds to a time point associated with a discernible decrease in the fuel pressure 34 proximal to the fuel injector 10. The sensed EOI time 317 corresponds to a time point associated with a discernible inflection point in the injector voltage 42 from a decreasing voltage to an increasing voltage. Determining the sensed EOI time 317 corresponding to the time point associated with a discernible inflection point in the injector voltage 42 from a decreasing voltage to an increasing voltage is known to a person having ordinary skill in the art. A sensed injection duration 325 is an elapsed time period between the sensed SOI time 313 and the sensed EOI time 317. A maximum decrease 319 in the fuel pressure 34 proximal to the fuel injector 10 during the fuel injection event correlates with a maximum fuel injection rate, which may be determined using suitable calibration methods for an embodiment of the system. The maximum fuel injection rate and the sensed injection duration 325 may be used to calculate or otherwise determine an injected fuel mass for the fuel injection event.

FIG. 4 illustrates a control scheme 400 in the form of a flowchart to determine an injected fuel mass for a fuel injection event for an individual fuel injector, e.g., the fuel injector 10 described with reference to FIG. 1, using the injector parameters described with reference to FIG. 3.

Table 1 is provided as a key wherein the numerically labeled blocks and the corresponding functions are set forth as follows.

TABLE 1

| BLOCK | BLOCK CONTENTS |
|---|---|
| 400 | Control scheme |
| 402 | Monitor Pr_inj, V_Inj |
| 404 | Determine SOI(Pr_Inj) |
| 406 | Determine EOI(V_Inj) |
| 408 | Determine ΔPr_Inj_Max |
| 410 | Calculate T_Inj = EOI(V_Inj) − SOI(Pr_Inj) |
| 412 | Calculate Mmax = K1*(ΔPr_Inj_Max) |
| 414 | Calculate M_Inj = K2*(T_Inj *Mmax) |
| 416 | End |

The control scheme 400 includes monitoring the fuel pressure (Pr_Inj) 34 proximal to the fuel injector 10 and monitoring voltage across the solenoid of the fuel injector (V_Inj) 42 in response to a commanded injector pulsewidth (402). A sensed SOI time corresponding to the fuel pressure (SOI(Pr_Inj)) is determined (404). In one embodiment the sensed SOI time corresponding to the fuel pressure (SOI(Pr_Inj)) corresponds to a time point associated with a discernible decrease in the fuel pressure 34 proximal to the fuel injector 10, i.e., the sensed SOI time 313 shown with reference to FIG. 3. A sensed EOI time corresponding to the voltage across the solenoid of the fuel injector EOI(V_Inj) is determined (406). In one embodiment the sensed EOI time corresponding to the voltage across the solenoid of the fuel injector EOI(V_Inj) corresponds to a time point associated with a discernible inflection point in the injector voltage 42 from a decreasing voltage to an increasing voltage, i.e., the sensed EOI time 317 shown with reference to FIG. 3.

A maximum drop in the fuel pressure (ΔPr_Inj_Max) during the fuel injection event is determined based upon the monitored fuel pressure (408). In one embodiment the maximum drop in the fuel pressure (ΔPr_Inj_Max) corresponds to the maximum decrease 319 in the fuel pressure 34 proximal to the fuel injector 10 during the fuel injection event shown with reference to FIG. 3.

The sensed injection duration (T_Inj) is calculated as a difference between the sensed SOI time and the sensed EOI time (410). In one embodiment the sensed injection duration (T_Inj) corresponds to the sensed injection duration 325 shown with reference to FIG. 3.

A maximum fuel injection rate (Mmax) correlates with the maximum drop in the fuel pressure (ΔPr_Inj_Max) (412) and is calculated as follows in EQ. 1:

Mmax=K1*(ΔPr_Inj_Max) [1]

wherein K1 is a scalar term that provides the correlation between the maximum drop in the fuel pressure (ΔPr_Inj_Max) and the maximum fuel injection rate (Mmax). The K1 scalar term correlates to a line fuel pressure, fuel temperature, and other engine operating parameters. In one embodiment, there is a plurality of K1 scalar terms, each which is preferably predetermined in relation to monitored engine parameters. In operation, the plurality of K1 scalar terms is executed as an array, with a routine configured to retrieve one of the K1 scalar terms from the array in response to the monitored engine parameters.

An injected fuel mass (M_Inj) for the fuel injection event corresponds to the sensed injection duration (T_Inj) and the maximum injection mass flowrate (Mmax). The injected fuel mass may be calculated as a product of the sensed injection duration (T_Inj) and the maximum injection mass flowrate (Mmax) adjusted with a predetermined scalar term K2 (414) as shown below in EQ. 2.

M_Inj=K2*(T_inj*Mmax) [2]

The injected fuel mass is correlated with the commanded injector pulsewidth, i.e., a commanded injection duration for use as a control parameter. The K2 scalar term correlates to a line fuel pressure, fuel temperature, and other engine operating parameters. In one embodiment, there is a plurality of K2 scalar terms, each which is preferably predetermined in relation to monitored engine parameters. In operation, the plurality of K2 scalar terms is executed as an array, with a routine configured to retrieve one of the K2 scalar terms from the array in response to the monitored engine parameters including the line fuel pressure, fuel temperature, and other engine operating parameters.

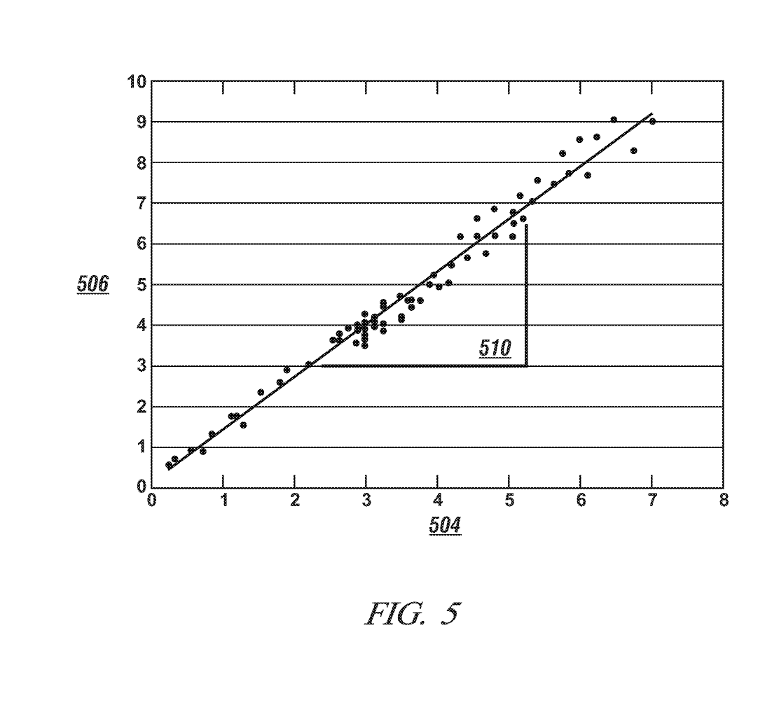

FIG. 5 graphically illustrates injected fuel (mg) 506 on the y-axis in relation to the product of the measured injection duration and the maximum injection mass flowrate on the x-axis 504, and having a slope 510. The slope 510 correlates to the predetermined scalar term K2 depicted with reference to EQ. 2. The results are for the same four electromagnetically-activated direct-injection fuel injectors at low commanded injection durations depicted in FIG. 2. The results indicated that there is a linear relation having the slope 510 between the injected fuel mass and a multiplicative product of the sensed injection duration and the maximum injection mass flowrate.

A linearized relation between the injector command signal 52 and an injected fuel mass is preferably developed to achieve precise control of injected fuel mass, which is particularly suited for fuel injection events in a low injector flow region, e.g., in a region between 0.25 ms of fuel flow and 0.60 ms of fuel flow at a line fuel pressure of 20 MPa in one embodiment. A control scheme may be developed that monitors the sensed SOI time 313, the sensed EOI time 317, and the maximum drop in the fuel pressure 319 and employs the linearized relation between the injector command signal 52 and the injected fuel mass to achieve precise control of injected fuel mass in the low injector flow region. Such a control scheme may be in the form of a predetermined multidimensional array of values stored in a memory device in the control module or another suitable control scheme. The control scheme is particularly suited to achieve improved control of small injection quantities and reduce injector-to-injector variability when metering small quantities of fuel.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any controller executable instruction sets including calibrations and look-up tables. The control module has a set of control routines executed to provide the desired functions. Routines are executed, such as by a central processing unit, and are operable to monitor inputs from sensing devices and other networked control modules, and execute control and diagnostic routines to control operation of actuators. Routines may be executed at regular intervals, for example each 3.125, 6.25, 12.5, 25 and 100 milliseconds during ongoing engine and vehicle operation. Alternatively, routines may be executed in response to occurrence of an event.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method for determining injected fuel mass delivered from an electromagnetic solenoid-activated fuel injector during a fuel injection event, comprising:
determining a sensed injection duration and a maximum injection mass flowrate during the fuel injection event; and
determining the injected fuel mass for the fuel injection event based on the sensed injection duration and the maximum injection mass flowrate during the fuel injection event.

2. The method of claim 1, wherein determining the injected fuel mass for the fuel injection event comprises calculating the injected fuel mass in accordance with the following relationship:
M_Inj=K2*(T_Inj*Mmax)
wherein
M_Inj is the injected fuel mass,
T_Inj is the sensed injection duration,
MMax is the maximum injection mass flowrate, and
K2 is a scalar term.

3. The method of claim 2, wherein the K2 scalar term is determined in relation to a fuel pressure.

4. The method of claim 1, wherein determining the sensed injection duration comprises:
determining a first time point corresponding to a discernible decrease in a fuel pressure;
determining a second time point corresponding to a discernible inflection point in an injector voltage; and
calculating the sensed injection duration as an elapsed time period between the first and second time points.

5. The method of claim 4, wherein said fuel pressure comprises a fuel pressure proximal to the fuel injector.

6. The method of claim 1, wherein determining the maximum injection mass flowrate comprises:
detecting a maximum drop in a fuel pressure during the fuel injection event; and
determining the maximum injection mass flowrate based on the maximum pressure drop in the fuel pressure during the fuel injection event.

7. The method of claim 1, further comprising correlating the injected fuel mass for the fuel injection event to an injector command signal for the fuel injection event.

8. Method for operating a fuel injector, comprising:
determining a sensed injection duration for a fuel injection event comprising an elapsed time period between a discernible decrease in a fuel pressure and a discernible inflection point in an injector voltage;
determining a maximum injection mass flowrate based on a maximum pressure drop in the fuel pressure during the fuel injection event; and
determining an injected fuel mass for the fuel injection event based on the sensed injection duration and the maximum injection mass flowrate.

9. The method of claim 8, wherein determining the injected fuel mass for the fuel injection event comprises calculating the injected fuel mass in accordance with the following relationship:
M_Inj=K2*(T_Inj*Mmax)
wherein
M_Inj is the injected fuel mass,
T_Inj is the sensed injection duration,
MMax is the maximum injection mass flowrate, and
K2 is a scalar term.

10. The method of claim 9, wherein the K2 scalar term is determined in relation to the fuel pressure.

11. The method of claim 8, wherein determining the sensed injection duration comprises:
monitoring the fuel pressure at a point proximal to the fuel injector and the injector voltage;
determining a first time point corresponding to the discernible decrease in the fuel pressure;
determining a second time point corresponding to the discernible inflection point in the injector voltage; and
calculating the sensed injection duration as an elapsed time period between the first and second time points.

12. The method of claim 8, wherein determining the maximum injection mass flowrate comprises:
monitoring the fuel pressure proximal to the fuel injector;
detecting the maximum drop in the fuel pressure during the fuel injection event; and
determining the maximum injection mass flowrate during the fuel injection event based on the maximum pressure drop in the fuel pressure during the fuel injection event.

13. Method for operating an electromagnetic solenoid-activated fuel injector, comprising:
determining an elapsed time period comprising a time period between a discernible decrease in a fuel pressure proximal to the fuel injector and a discernible inflection point in an injector voltage during a fuel injection event;
determining a maximum pressure drop in the fuel pressure during the fuel injection event; and
determining an injected fuel mass based on the elapsed time period and the maximum pressure drop in the fuel pressure.

14. The method of claim 13, wherein determining the injected fuel mass comprises calculating the injected fuel mass in accordance with the following relationship:
M_Inj=K2*(T_Inj*Mmax)
wherein
M_Inj is the injected fuel mass,
T_Inj is the elapsed time period,
MMax is a maximum injection mass flowrate corresponding to the maximum pressure drop in the fuel pressure during the fuel injection event, and
K2 is a scalar term.

15. The method of claim 14, wherein the K2 scalar term is determined in relation to the fuel pressure.
